(19) United States
(12) Patent Application Publication
(10) Pub. No.: US 2011/0226561 A1
(43) Pub. Date: Sep. 22, 2011

(54) ELEVATOR INSTALLATION FASTENING DEVICES

(76) Inventors: Agnaldo Santos, Sao Paulo (BR); Eduardo Felipeli, Taboao da Serra (BR)

(21) Appl. No.: 13/051,225

(22) Filed: Mar. 18, 2011

(30) Foreign Application Priority Data
Mar. 18, 2010 (EP) 10156849.1

(51) Int. Cl. B66B 7/02; F16M 13/02

(52) U.S. Cl. 187/408; 248/220.21; 248/222.14

(57) ABSTRACT

A fastening device for use in an elevator installation comprises a V-shaped base body with first and second limb profile members. The fastening device can be used to fasten at least one elevator guide rail to the wall of an elevator shaft.

### FIELD

The present disclosure relates to fastening devices for use in an elevator installation.

### BACKGROUND

An elevator installation usually comprises an elevator cage and a counterweight, which are moved in an elevator shaft in opposite direction. The elevator cage and the counterweight in that regard run in or along corresponding guide rails. The guide rails are typically formed from profile members which are joined together in vertical alignment in the elevator shaft.

A guide rail typically has a T-shaped profile, comprising a base and a web, which is formed centrally on the base and which extends inwardly in direction towards the elevator cage or the counterweight unit. The corresponding rail profiles have in the past been fastened to the shaft wall by constructionally complicated elements.

An example of appropriate fastening means is evident from Patent Application DE 101 26 833 B4. In this connection, reference is made by way of example to FIG. 2 of this patent specification.

It is a disadvantage of the known fastening means that they are constructionally complicated and relatively heavy. Moreover, problems with absorption and dissipation of force arise in the case of alternating loading.

### SUMMARY

Some embodiments described herein disclose improved fastening devices for use in an elevator installation in order to avoid the disadvantages of previously known solutions. Above all, it is a matter of making possible a simple, quick and robust fastening of T-shaped guide rails.

Further embodiments provide universally usable fastening devices which can be employed in different types of elevators and for different T-shaped guide rails.

Further embodiments provide a correspondingly equipped elevator installation which is furnished with at least one secure and reliable fastening device.

Some embodiments allow for the improvement and simplification of the installation and alignment of the guide rails used in elevator systems. Moreover, the time required for erection and maintenance of the guide rails of an elevator installation can be reduced.

### BRIEF DESCRIPTION OF THE DRAWINGS

The disclosure is explained in more detail symbolically and by way of example with reference to the figures. The figures are described conjunctively and in general.

In that case:

FIG. 1 shows a perspective illustration of a section of an elevator installation with a first fastening device;

FIG. 2 shows a schematic plan view of a sheet metal body of the first fastening device;

FIG. 3A shows a schematic underneath view of a displaceable rail clamp and a section of a vertical surface of an angle body;

FIG. 3B shows a schematic side view of a further displaceable rail clamp and a section of a vertical surface of an angle body;

FIG. 4 shows a plan view of a further fastening device;

FIG. 5 shows a side view of a further fastening device;

FIG. 6 shows a side view of a further fastening device;

FIG. 7A shows a plan view of a schematic vector diagram;

FIG. 7B shows a plan view of a further schematic vector diagram; and

FIG. 8 shows a side view of a part of a further fastening device, in an exploded illustration.

### DETAILED DESCRIPTION

The following generally applies to the drawings and the further description:
The figures are to be considered true to scale, even when individual aspects are illustrated in simplified or schematic form.
Constructional elements which are the same or similar or function in the same or similar manner are provided in all figures with the same reference numerals.
Statements such as right, left, above and below refer to the respective arrangement in the figures.

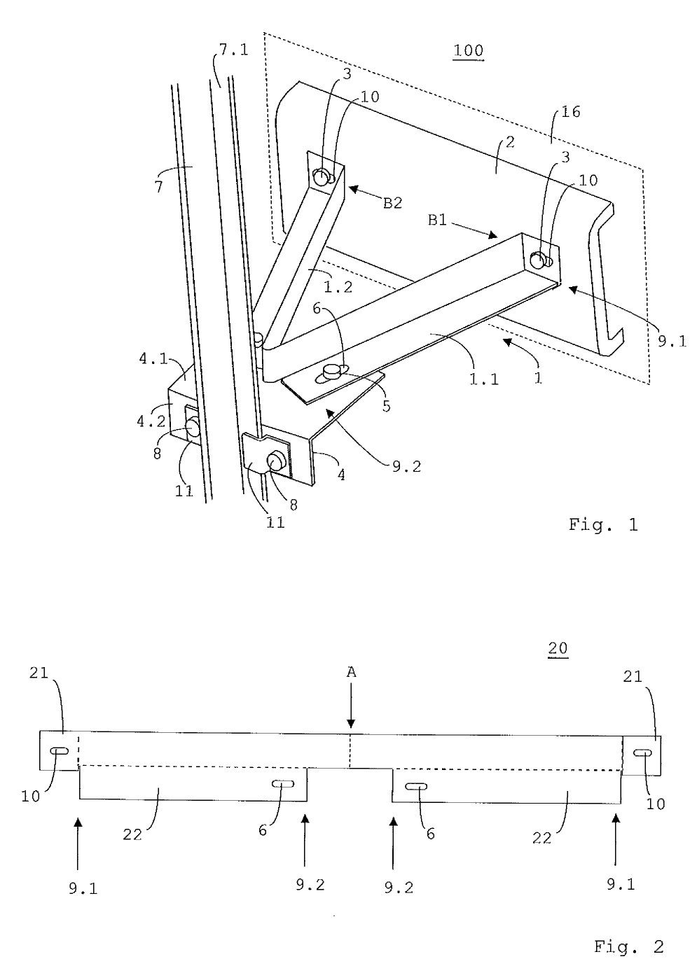

At least some embodiments are particularly suitable for fastening T-shaped guide rails 7 parallel to a shaft wall 16 of an elevator shaft, as indicated in FIG. 1. A section of such a guide rail 7 is shown in FIG. 1.

Details of a first fastening device 100 for use in an elevator installation are shown in FIG. 1. In FIG. 1 a transverse profile member 2, which can be fastened to a vertical shaft wall 16 or can be part of such a shaft wall 16, is shown. In addition, a section of a guide rail 7 can be seen, which is so arranged that it extends perpendicularly in the elevator shaft and parallel to the shaft wall 16. The guide rail 7 is fastened to an angle body 4 by at least one fastening device 100 with two rail clamps 11, which are designed for engaging around vertical sections 7.1 of the guide rail 7. The angle body 4 is carried by a V-shaped base body 1, which produces the connection with the shaft wall 16 directly or indirectly.

The V-shaped base body 1 comprises two limb profile members 1.1, 1.2 as shown. First fastening devices 3, 10 for mechanical fastening of the V-shaped base body 1 to the profile member 2 or the shaft wall 16 are provided at each of the limb profile members 1.1, 1.2 at a first extreme end 9.1. Second fastening devices 5, 6, which are designed for mechanical fastening of the V-shaped base body 1 to the angle body 4, are present at the opposite, second extreme end 9.2.

The V-shaped base body 1 can be constructed as follows. It comprises the two mentioned limb profile members 1.1, 1.2, which run towards one another to a tip in the region of the extreme end 9.2 and are there connected together. At the opposite extreme end 9.1 the two limb profile member 1.1, 1.2 are spaced from one another and thereby define two fastening points B1, B2 for fastening to the profile member 2 or to the shaft wall 16.

The entire base body 1 can be made from sheet metal by bending and/or deep-drawing. Respectively shown in FIGS. 1, 4, 5, 6 and 8 are base bodies 1 which were produced by punching of a metal sheet and by bending of a punched sheet metal body 20. Such a sheet metal body 20 after punching and before bending is shown in FIG. 2. This is a purely schematic illustration, which is not to scale. The fold edges are illustrated in FIG. 2 by dotted lines. Straps 21, which later in the mounted state sit parallel to the profile member 2 or the shaft wall 16, are constructed in the region of the first extreme end 9.1. Each of these straps 21 has a slot 10. However, a simple round hole can also be provided here, depending on the respective fastening equipment to be used for fastening to the shaft wall 16. In one form of embodiment according to FIG. 6, no straps 21 are required, since fastening is carried out by means of an angle fastener. Longitudinal straps 22 extend between the first extreme ends 9.1 and the second extreme ends 9.2. These longitudinal straps 22 each have a respective slot 6. However, a simple round hole can also be provided here, depending on the respective fastening equipment to be used for fastening to the angle body 4. The tip of the V-shaped base body 1 is formed in the region A. The sheet metal body 20 can be bent in this region A in such a manner that a transition with small radius of curvature is formed. The radius of curvature is so selected that neither excessive loading nor breaking of the sheet metal can occur.

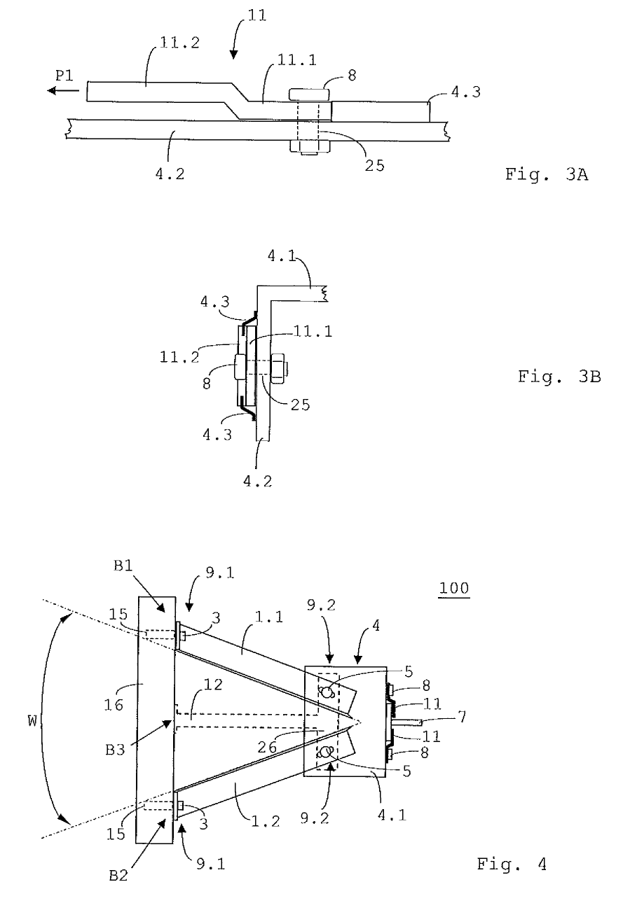

The angle body 4 preferably comprises a horizontal surface 4.1, which lies parallel to a plane spanned by the V-shaped base body 1. This plane is perpendicular to the shaft walls 16. The limbs 1.1, 1.2 of the V-shaped base body 1, i.e. the longitudinal straps 22, lie, if the V-shaped base body 1 is made from a sheet metal body 20 according to FIG. 2, in the mounted state on the horizontal surface 4.1. Here, holes (e.g., elongated holes) (not shown) can be provided in the horizontal surface 4.1 so as to be able to use a screw, rivet or a pin 5 for the fastening. In addition, the angle body 4 has a vertical surface 4.2 which is perpendicular to the horizontal surface 4.1 and which in the mounted state extends parallel to the shaft wall 16. In this vertical surface 4.2 holes 25 (e.g., elongated holes) (see FIGS. 3A and 3B) can be provided in order to be able to use a screw, a rivet or a pin 8 for fastening the rail clamps 11.

In order to be able to connect the guide rail 7 with the angle body 4, use can be made here of the already mentioned rail clamps 11. Such a rail clamp 11 has, in horizontal cross-section, a slight S-shape or Z-shape with two vertical surfaces 11.1 and 11.2, as shown in FIG. 3A by way of a schematic example. Of the vertical surfaces, in the mounted state one vertical surface 11.1 lies flatly on the vertical surface 4.2 of the angle body 4 and one vertical surface 11.2 lies flatly on the vertical section 7.1 of the guide rail 7. The vertical surface 11.2 or a vertical section of the rail clamp 11 engages around at least a small region of the vertical section 7.1 of the guide rail 7. The entire guide rail 7 is drawn against the vertical surface 4.2 of the angle body 4 by firm tightening of a screw or by the use of a rivet or a pin 8.

The angle body 4 preferably comprises a horizontal guide 4.3 for the rail clamps 11, so that the rail clamps 11 can be fastened to and slid at the angle body 4 without dropping off or being lost. The sliding of the rail clamps 11 is indicated in FIG. 3A by an arrow P1. This measure considerably facilitates assembly.

FIG. 3B shows a form of embodiment of the angle body 4 with two horizontal guides 4.3 for holding and mounting a rail clamp 11. The rail clamp 11 can here (if the screw 8 is not tightened) be slid in the drawing plane into or out of the drawing plane.

A plan view of the first fastening equipment 100 is shown in FIG. 4. The fastening equipment 100 is here screw-connected directly with the shaft wall 16 at two (or three) fastening points B1, B2 (and optionally also at B3), as indicated by screw holes or peg holes 15. The V-shaped base body 1 spans a plane, which here lies in the drawing plane. An angle W, which is preferably between 10 and 45 degrees, arises between the two limbs 1.1, 1.2.

In FIG. 4 it is indicated that the fastening equipment 100 can additionally comprise a support profile member 12, which here is illustrated by dotted lines. This support profile member 12 is fastened to the V-shaped base body 1 so as to form together with the two limb profile members 1.1, 1.2 a tripod which is connected directly or indirectly with the shaft wall 16 at three points B1, B2, B3 (in FIG. 4 a direct connection with the shaft wall 16 is shown). The support profile member 12 can be constructed in the form of an obliquely disposed strut and can have a support surface 26 which is fastened below the horizontal surface 4.1 of the angle body 4. In FIG. 4 it is indicated that this support surface 26 can have, for example, a rectangular outline. At the other end, the support profile member 12 can be fastened to the shaft wall 16 or to the profile member 2.

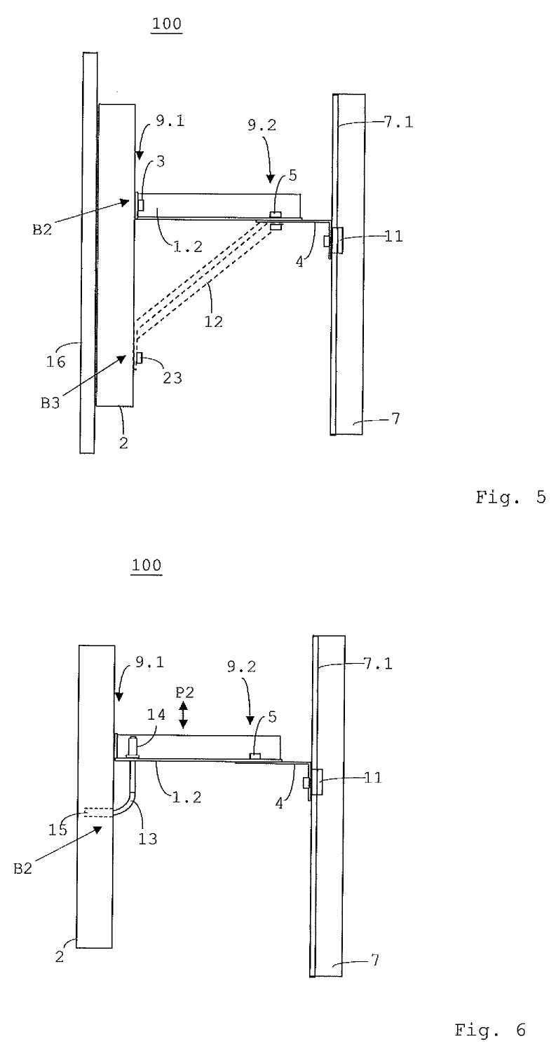

A side view of further fastening equipment 100 is shown in FIG. 5. The fastening equipment 100 can be screw-connected at two (or three) fastening points B1, B2 (and optionally also at the point B3) with a profile member 2 which can be seated in front of a shaft wall 16, as indicated in FIG. 5, or which can be integrated in the shaft wall 16. It is also indicated in FIG. 5 that the fastening equipment 100 can additionally comprise a support profile member 12, which here is illustrated by dashed lines. In FIG. 5 it can be seen that the support profile member 12 can be fastened by, for example, a screw 23. The screw, rivet or the pin 5 can be designed so that it connects not only the V-shaped base body 1, but also the optional support profile member 12 with the angle body 4. However, use can also be made at this point of separate fastening devices.

A side view of further fastening equipment 100 is shown in FIG. 6. The fastening equipment 100 here comprises for each limb 1.1, 1.2 a so-called angle fastener 13 and a sleeve 14. The angle fastener 13 defines a 90-degree angle, so that one end of the angle fastener 13 passes through an underside of the V-shaped base body 1 (for example through the longitudinal strap 22) and a second end perpendicular thereto can be inserted or screwed into the profile member 2 or the shaft wall 16. A peg hole or screw hole 15 is therefore indicated in FIG. 6. It is indicated in FIG. 6 by the arrow P2 that the guide rail 7 inclusive of the fastening equipment 100 can execute a small upward or downward movement, since the sleeve 14 can slide upwardly and downwardly along the angle fastener 13. Thus, absorption of or compensation for, for example, slight expansion movements which can arise in the case of changes in temperature can be provided.

Another form of embodiment appears in FIG. 8, in which additionally to the sleeve 14 a metal sleeve or a metal cylinder 18 is also used, which, for example, is fastened to the limb 1.2 of the V-shaped base body 1 (for example welded) and seated coaxially with respect to the hole 19 in the limb 1.2 (or the longitudinal strap 22 of the limb 1.2). The angle fastener 13, which can have a thread 24 at one end, is pushed from below into the sleeve 14 and together with the sleeve 14 inserted into the metal sleeve or the metal cylinder 18 at the limb 1.2. The metal sleeve or the metal cylinder 18 can be used in all forms of embodiments.

The sleeve 14 can be a plastics material sleeve. For example, ‘Teflon’ sleeves can be used. The plastics material sleeve can be used in all forms of embodiment.

The fastening equipment 100 can be very simple to mount in the various forms of embodiment. Moreover, it can be light and easy to handle.

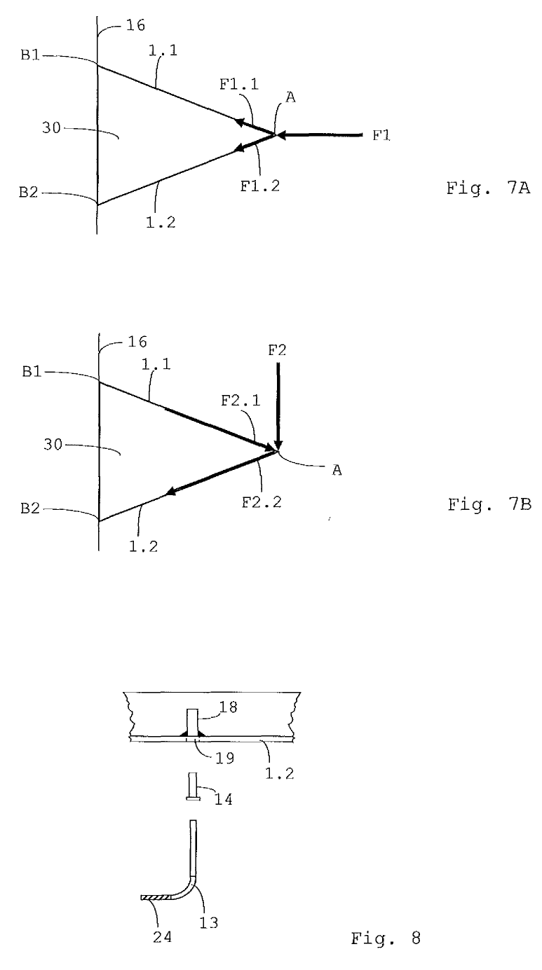

It is schematically illustrated by way of FIGS. 7A and 7B how the fastening equipment 100 can accept different forces. In these figures the V-shaped base body is symbolized by an equilateral triangle 30.

FIG. 7A illustrates a situation in which a force F1 presses perpendicularly on the guide rail 7 and thus also perpendicularly on the V-shaped base body 1 (here shown as triangle 30). The force vector F1 is resolved into two vectors F1.1 and F1.2, which are of equal magnitude and which are each oriented in the direction of one of the limbs 1.1, 1.2 of the triangle 30 or the base body 1. These forces are conducted into the shaft wall 16. If the force F1 were to act in the opposite direction, an inversion of the illustrated situation results and there is equal pulling at the two limbs 1.1, 1.2.

FIG. 7B illustrates a situation in which a force F2 presses laterally on the guide rail 7. The force vector F2 is resolved into two vectors F2.1 and F2.2, which are of equal magnitude and which each oriented in the direction of one of the limbs 1.1, 1.2. The force vector F2.1 pulls at the limb 1.1 and a force vector F2.2 is introduced into the limb 1.2, i.e. this limb 1.2 is loaded by a pressure.

Other load situations can also be derived analogously on the basis of these two examples.

If use is made of a support profile member 12, then vertical forces (i.e. forces which run in shaft longitudinal direction or in longitudinal direction of the guide rail 7) can be better absorbed. The support profile member 12 can be used in all forms of embodiment. The angle fastener 13 with sleeve 14 and/or metal cylinder 18 can also be used in all forms of embodiment.

The fastening equipment 100 can ensure, in all forms of embodiment, a uniform and robust distribution of force. The entire elevator installation can thereby be more stable and the elevator cage or counterweight runs more smoothly.

Assembly can be simple and without problems. The costs for production of the fastening equipment 100 can be less than in the case of past solutions. This applies particularly to solutions which are made from sheet metal, as described. By comparison with at least some previously known solutions, a significant amount of material is saved.

A slot can be used at least at one point of the fastening equipment 100 in order to be able to provide compensation on site for tolerances during assembly. Two or more slots can be used in at least some embodiments.

In some embodiments, the rail clamps 11 are designed as slide elements, which can be fastened at any desired position of the vertical section 7.1 of the guide rail 7.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. An elevator installation fastening device, comprising a V-shaped, single-piece base body comprising first and second limb profile members, each of the first and second limb profile members comprising opposing first and second ends, each of the first ends comprising respective first fastening devices, the first fastening devices being configured to mechanically fasten the base body to an elevator shaft wall, each of the second ends comprising respective second fastening devices, the second fastening devices being configured to mechanically fasten the base body to an elevator guide rail using an angle body.

2. The elevator installation fastening device of claim 1, wherein the first and second limb profile members are angled between 10 degrees and 45 degrees relative to each other.

3. The elevator installation fastening device of claim 1, wherein the first and second limb profile members are made from bended sheet metal.

4. The elevator installation fastening device of claim 1, wherein the first and second limb profile members are made from deep-drawn sheet metal.

5. The elevator installation fastening device of claim 1, wherein the respective first fastening devices each comprise a screw, a pin or a rivet.

6. The elevator installation fastening device of claim 1, wherein the respective first fastening devices each comprise a respective angle fastener and at least one respective sleeve.

7. The elevator installation fastening device of claim 1, further comprising a support profile member configured to couple to the elevator shaft wall and to the angle body.

8. An elevator installation comprising:
an elevator guide rail vertically extending along at least a portion of an elevator shaft; and
an elevator installation fastening device, the fastening device comprising a V-shaped, single-piece base body comprising first and second limb profile members, each of the first and second limb profile members comprising opposing first and second ends, each of the first ends comprising respective first fastening devices, the first fastening devices being fastened to a wall of the elevator shaft, each of the second ends comprising respective second fastening devices, the second fastening devices being fastened to the at least one elevator guide rail using an angle body.

9. The elevator installation of claim 8, wherein the first and second limb profile members are angled between 10 degrees and 45 degrees relative to each other.

10. The elevator installation of claim 8, wherein the first and second limb profile members are made from bended sheet metal.

11. The elevator installation of claim 8, wherein the first and second limb profile members are made from deep-drawn sheet metal.

12. The elevator installation of claim 8, wherein the respective first fastening devices each comprise a screw, a pin or a rivet.

13. The elevator installation of claim 8, wherein the respective first fastening devices each comprise a respective angle fastener and at least one respective sleeve.

14. The elevator installation of claim 8, the elevator installation fastening device further comprising a support profile member configured to couple to the elevator shaft wall and to the angle body.

15. An elevator installation apparatus, comprising a one-piece bracket having first and second legs, the first and second legs being connected at respective first ends and separated from each other at respective second ends, the respective first ends comprising fasteners for attaching the apparatus to an elevator guide rail, and the respective second ends comprising fasteners for attaching the apparatus to an elevator shaft wall.
